(19) United States
(12) Patent Application Publication
(10) Pub. No.: US 2014/0193848 A1
(43) Pub. Date: Jul. 10, 2014

(54) SAMPLE VIAL CAP AND SAMPLE VIAL FOR USE IN PREPARING CYTOLOGICAL SPECIMEN AND METHOD OF PREPARING CYTOLOGICAL SPECIMEN

(71) Applicant: HOLOGIC, INC., Marlborough, MA (US)

(72) Inventor: Howard B. Kaufman, Newton, MA (US)

(73) Assignee: HOLOGIC, INC., Marlborough, MA (US)

(21) Appl. No.: 13/737,778

(22) Filed: Jan. 9, 2013

(51) Int. Cl. B01L 3/00

(52) U.S. Cl. CPC B01L 3/508
USPC 435/29; 422/570; 422/558

(57) ABSTRACT

A cap configured for use with a specimen container includes a cap body having a top surface defining an opening therethrough, a torque pattern disposed on the top surface of the cap body, and a pierceable and self-resealing membrane disposed across the opening, where, when the membrane is intact or resealed, the membrane forms a fluid-tight seal across the opening.

### FIELD OF THE INVENTION

This invention relates to apparatus for storing fluid samples adapted for use with an automated cytological specimen preparation system.

### BACKGROUND OF THE INVENTION

Cytology is a branch of biology dealing with the study of the formation, structure, and function of cells. As applied in a laboratory setting, cytopathologists, cytotechnologists, and other medical professionals make medical diagnoses of a patient's condition based on visual examination of a specimen of the patient's cells. A typical cytological technique is a “pap smear” test, in which cells are scraped from a woman's cervix and analyzed in order to detect the presence of abnormal cells, a precursor to the onset of cervical cancer. Cytological techniques are also used to detect abnormal cells and disease in other parts of the human body.

Cytological techniques are widely employed because collection of cell samples for analysis is generally less invasive than traditional surgical pathological procedures such as biopsies, whereby a tissue specimen is excised from the patient using specialized biopsy needles having spring loaded translatable stylets, fixed cannulae, and the like. Cell samples may be obtained from the patient by a variety of techniques including, for example, by scraping or swabbing an area, or by using a needle to aspirate body fluids from the chest cavity, bladder, spinal canal, or other appropriate area. The cell samples are placed in solution and subsequently collected and transferred to a glass slide for viewing under magnification. Fixative and staining solutions may be applied to the cells on the glass slide for preserving the specimen for archival purposes and for facilitating examination.

It is generally desirable that the cells on the slide have a proper spatial distribution, so that individual cells can be examined. A single layer of cells is typically preferred. Accordingly, preparing a specimen from a fluid sample containing many cells typically requires that the cells first be separated from each other by mechanical dispersion, fluidic shear, or other techniques so that a thin, monolayer of cells can be collected and deposited on the slide. In this manner, the cytotechnologist can more readily discern abnormal cells. The cells are also able to be counted to ensure that an adequate number of cells have been evaluated.

Certain methods, apparatus, and materials for generating a thin monolayer of cells on a slide advantageous for visual examination are disclosed in U.S. Pat. No. 5,143,627 issued to Lapidus et al. and entitled “Method and Apparatus for Preparing Cells for Examination;” U.S. Pat. No. 5,240,606 issued to Lapidus et al. and entitled “Apparatus for Preparing Cells for Examination;” and U.S. Pat. No. 5,256,571 issued to Hurley et al. and entitled “Cell Preservative Solution,” all of which are assigned to the assignee of the present invention and all of the disclosures of which are incorporated herein by reference in their entirety. Sample vials and automated systems for uncapping and capping same are disclosed in U.S. Pat. No. 7,556,777 issued to Victor and entitled “Specimen Vial Cap Handler and Slide Labeler;” U.S. Pat. No. 7,579,190 issued to Ostgaard et al. and entitled “Method and Apparatus for Preparing Cytological Specimens;” and U.S. Pat. No. and U.S. Pat. No. 7,887,758 issued to Ostgaard et al. and entitled “Sample Vial for Use in Preparing Cytological Specimen,” which are also all assigned to the assignee of the present invention and all of the disclosures of which are also incorporated herein by reference in their entirety.

According to one method disclosed in these patents, a patient's cells in a preservative fluid in a sample container are dispersed using a spinning sample collector disposed therein. A controlled vacuum is applied to the sample collector to draw the fluid through a screen filter thereof until a desired quantity and spatial distribution of cells is collected against the filter. Thereafter, the sample collector is removed from the sample container and the filter portion impressed against a glass slide to transfer the collected cells to the slide in substantially the same spatial distribution as collected.

While apparatus manufactured according to the teachings of one or more of these patents have been commercially successful, such as the ThinPrep® 2000 System manufactured and sold by Hologic, Inc. located in Bedford, Mass., such apparatus requires substantially constant attendance by a trained operator. For example, for each specimen to be prepared, the operator must load the system with an open sample vial containing the patient's cells in preservative fluid, a sample collector with filter, a glass slide, and an open fixative bath vial containing a fixative solution. The system then cycles automatically, the cells being dispersed by the sample collector, collected against the filter, and transferred to the slide. The slide is then automatically deposited in the fixative bath vial where it must be retrieved by the operator for manual loading in a staining rack for further processing. Thereafter, the sample vial and sample collector must be removed from the system, to avoid inter-sample contamination, before replacements and a new slide are installed to produce another specimen from a different patient's sample.

Once a specimen is prepared, fixed, and stained, the specimen may be manually visually inspected by a cytotechnologist, typically under magnification, and with or without various sources of illumination. Alternatively or additionally, automated machine vision systems have been adapted to aid cytological inspection. For example, an automated vision system may perform a preliminary assessment of the entire slide on which the specimen is disposed to alert the cytotechnologist to potentially the most relevant areas of the slide for close inspection, or may be used to rescreen specimens already analyzed by the cytotechnologist.

Apparatus manufactured according to the teachings of one or more of these patents, such as the ThinPrep® 3000 System manufactured and sold by Hologic, Inc. located in Bedford, Mass., have been commercially successful. The ThinPrep® 3000 System includes an automatic uncapping/capping system. However, in other specimen processing equipment, such as Tecan fluid handlers, there is a need for easier and faster access to sample in the ThinPrep® vial. Also there is a need to further minimize any opportunity for cross-contamination of one sample to another sample.

### SUMMARY OF THE INVENTION

While automated specimen preparation systems and vials for use therewith, such as those described hereinabove, perform as designed, it is desirable to enable other specimen processing equipment to more easily and quickly access the sample in the vial without opening the vial cap. At the same time, it is desirable to further minimize cross-contamination.

In one embodiment, a cap configured for use with a specimen container includes a cap body having a top surface defining an opening therethrough; a torque pattern disposed on the top surface of the cap body; and a pierceable and self-resealing membrane disposed across the opening, where, when the membrane is intact or resealed, the membrane forms a fluid-tight seal across the opening. The top surface may define the opening approximately in a center of the torque pattern. The membrane and the opening may be configured such that, when the cap is attached to a specimen container, an interior of the specimen container is accessible through the membrane and cap opening. The membrane may be configured to self-seal a tear therein by returning opposite edges of the tear to a substantially contiguous closed condition. The membrane may include an elastomeric material. The torque pattern may include a plurality of radially disposed ribs, such as six, radially disposed, substantially equally-spaced apart ribs.

In another embodiment, a sample vial for use in an automated test apparatus includes a vial body comprising an outer surface, with at least one anti-rotation lug disposed about the vial body outer surface; a cap removably attachable to the vial body, and a seal disposed between an interior of the vial body and the cap so as to be capable of forming a substantially fluid-tight seal therebetween when the membrane is intact or resealed. The cap includes a cap body having a top surface defining an opening therethrough, a torque pattern disposed on the top surface of the cap, and a pierceable and self-resealing membrane disposed across the opening, where, when the membrane is intact or resealed, the membrane forms a fluid-tight seal across the opening. The top surface may define the opening approximately in a center of the torque pattern. The vial body, cap, and seal may be configured such that the interior of the vial body is accessible without removing the cap from the vial body by piercing the membrane. The membrane may be configured to self-seal a tear therein by returning opposite edges of the tear to a substantially contiguous closed condition. The membrane may include an elastomeric material. The torque pattern may include a plurality of radially disposed ribs.

The vial body, cap, and seal of the sample vial may be configured such that a substantially fluid-tight seal between the cap and the interior of the vial body is formed when either between about 5 and 50 inch-pounds, or about 20 inch-pounds of torque is applied to the cap relative to the vial body. The cap may include a first alignment marker, where the vial body comprises a second alignment marker, and where the first and second alignment markers indicate a fluid-tight seal when aligned. In such embodiments, the vial body, cap, and seal may be configured such that, when the first marker is aligned with the second marker, the cap may be removed from the vial body by applying less than about 25 inch-pounds of torque to the cap relative to the vial body. The cap may also include a first screw thread, where the vial body further comprises a second mating screw thread, and where the cap and the vial body are releasably engagable by an interaction between the first screw thread and the second mating screw thread.

In yet another embodiment, a method of accessing a fluid in a biological specimen container without removing a cap attached thereto or creating a permanent opening in the cap includes applying torque to a torque pattern disposed on a top surface of the cap to confirm a fluid-tight seal exists between the cap and an interior region of the container; piercing a membrane disposed on the cap with an elongate member; accessing the fluid inside the biological specimen container through the membrane using the elongate member; and removing the elongate member from the membrane to thereby allow the membrane to self-reseal. The method may also include accessing the fluid through the elongate member without contaminating an outer surface of the biological specimen container with the fluid.

Other and further aspects and features of embodiments of the disclosed invention will become apparent from the ensuing detailed description in view of the accompanying figures.

### BRIEF DESCRIPTION OF THE DRAWINGS

The drawings illustrate the design and utility of embodiments of the disclosed inventions, in which similar elements are referred to by common reference numerals. These drawings are not necessarily drawn to scale. The relative scale of select elements may have been exaggerated for clarity. In order to better appreciate how the above-recited and other advantages and objects are obtained, a more particular description of the embodiments will be rendered, which are illustrated in the accompanying drawings. These drawings depict only typical embodiments of the disclosed inventions and are not therefore to be considered limiting of its scope.

FIG. 1 is a schematic perspective view of a sample vial constructed in accordance with the teachings of the present invention depicting an assembled cap and body;

FIG. 2 is a schematic side view of the sample vial depicted in FIG. 1;

FIG. 3 is a schematic top view of the sample vial depicted in FIG. 1;

FIG. 4 is a schematic bottom view of the sample vial depicted in FIG. 1;

FIG. 5 is a detailed schematic cross-sectional view of the sample vial depicted in FIG. 1 through a diameter of the cap that does not intersect a rib;

FIG. 6 is a schematic perspective view of a rotatable interface for mating with a torque pattern of the sample vial cap;

FIG. 7 is a schematic perspective view of a unidirectional interface for mating with anti-rotation features of the sample vial body; and

FIG. 8 is a schematic perspective view of a bi-directional interface for mating with anti-rotation features of the sample vial body.

### DETAILED DESCRIPTION

For the following defined terms, these definitions shall be applied, unless a different definition is given in the claims or elsewhere in this specification.

All numeric values are herein assumed to be modified by the term “about,” whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

Various embodiments of the disclosed inventions are described hereinafter with reference to the figures. It should be noted that the figures are not drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention, which is defined only by the appended claims and their equivalents. In addition, an illustrated embodiment of the disclosed inventions needs not have all the aspects or advantages shown. An aspect or an advantage described in conjunction with a particular embodiment of the disclosed inventions is not necessarily limited to that embodiment and can be practiced in any other embodiments even if not so illustrated.

A sample vial 10 adapted for use with an automated cytological specimen preparation system capable of preparing specimens from a plurality of patient samples in a substantially unattended manner includes structural features for mating with a vial transfer assembly of the automated system. These structural features facilitate grasping of the closed, capped vial 10 by the vial transfer assembly, as well as removal and reinstallation of a mating cap 14. These structural features may include at least one anti-rotation lug 18 on the outer surface of a body 12 of the sample vial 10.

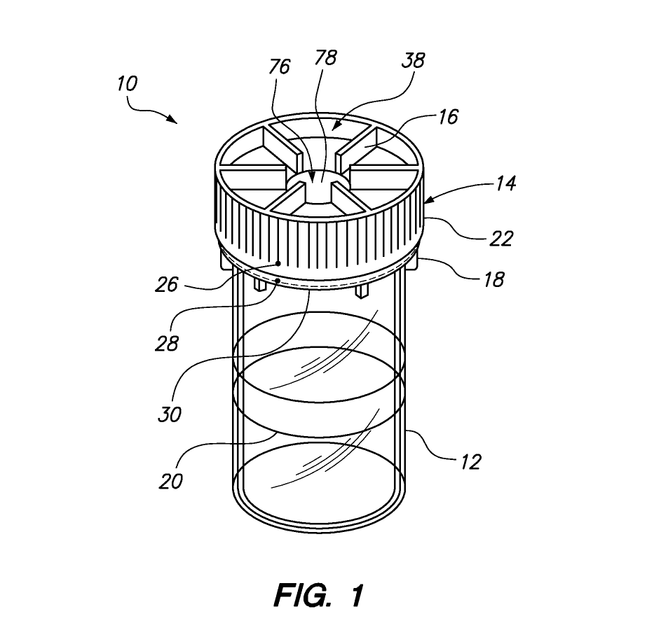

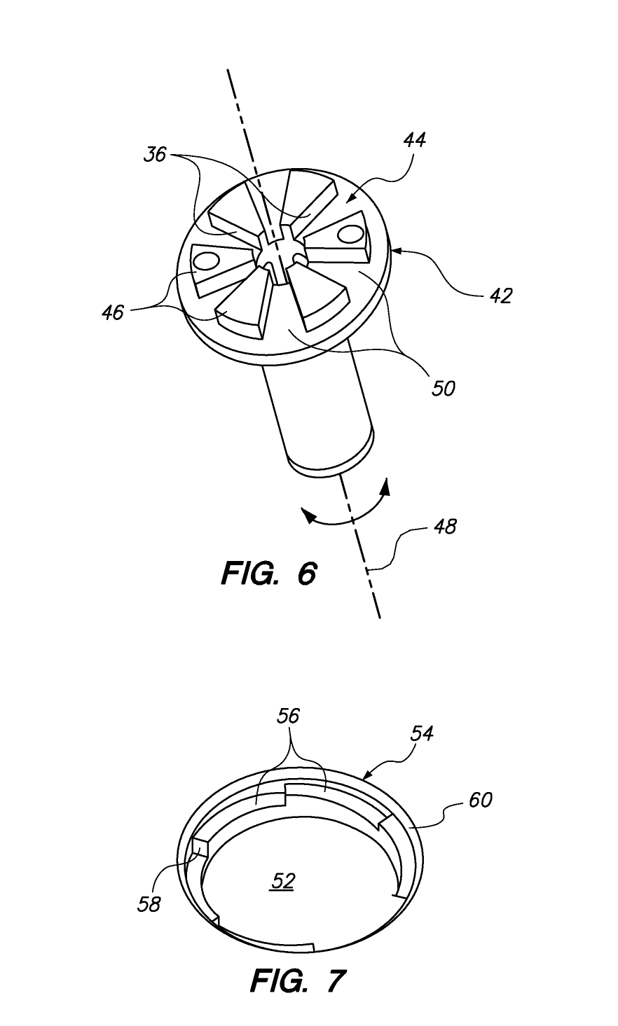

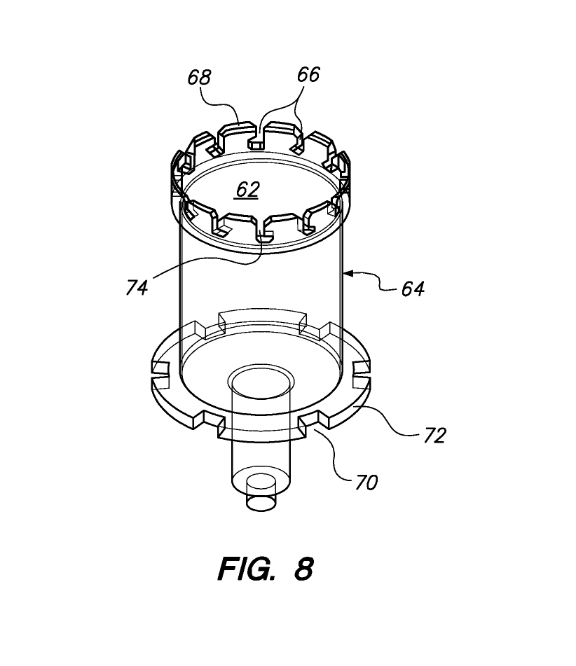

In one embodiment, depicted in FIG. 1, the vial body 12 includes six circumferentially disposed anti-rotation lugs 18, equi-spaced on an outer surface of the body 12. The anti-rotation lugs 18 are adapted for use with a storage tray and/or vial sleeve, as will be discussed in greater detail hereinbelow with respect to FIGS. 7 and 8. The lugs 18 prevent rotation of the body 12, thereby facilitating automated removal and reinstallation of the cap 14. The lugs 18 may be disposed advantageously proximate an open end of the body 12, near the cap 14. In this manner, opposing torques may be applied to both the body 12 and the cap 14 at approximately the same axial plane, thereby minimizing any moment induced in the vial 10 during removal and reinstallation of the cap 14 which would tend to roll the vial 10. The vial 10 may also include a flange 30 proximate the lugs 18 which can be used, for example, as a datum surface so that the vial 10 can be repeatably positioned at a predetermined height in the storage tray and vial sleeve.

A torque pattern, shown generally at 38, is disposed on the outer surface of the cap 14. The torque pattern 38 includes at least one generally radially disposed rib 16 and may include, for example, six, radially disposed, substantially equally-spaced apart ribs 16, forming a quasi-pie-shaped pattern consisting of six sectors surrounding a circular opening 76 defined by the cap 14, as depicted in FIG. 1. The torque pattern 38 is adapted for use with the rotatable interface of the vial transfer assembly to facilitate removal and reinstallation of the cap 14, as will be discussed in greater detail hereinbelow with respect to FIG. 6. The ribs 16 also provide structural support to the cap 14, so that changes in internal pressure in the vial 10, for example due to increases in ambient temperature and evaporation of the preservative solution, minimize doming and the likelihood of leakage. The cap 14 may include knurling 22 or other friction enhancing feature disposed on its outer circumferential surface. The knurling 22 facilitates the manual removal and reinstallation of the cap 14, as well as gripping of the cap 14 or the capped vial 10 by the vial transfer assembly. The knurling 22 may include a series of closely-spaced, generally axially disposed ridges.

As mentioned above, the cap 14 defines an opening 76 approximately in the center of an ellipsoid or, more particularly, circular top surface of the cap 14. The opening 76 is also ellipsoid or circular. The opening 76 extends through the cap 14 and is closed by a pierceable membrane 78 disposed across the opening 76. The membrane 78 allows an elongate device, such as a blunt pipette tip, to enter into and withdraw from the sample vial 10 without removing the cap 14 therefrom by puncturing the membrane 78. The membrane 78 may also be self-resealing such that a sample can be withdrawn from the vial 10 through the membrane 78 without compromising the integrity of the vial 10. The membrane 10 could be a single layer or multiple layers.

The membrane 78 may be made of an elastomer, such as a thermoplastic elastomer. The membrane 78 tends to stretch when distended, e.g., by pressing a blunt pipette tip against the membrane 78. As more pressure is applied to the pipette tip, the membrane 78 reaches the limit of its elasticity and a temporary tear forms therein, through which the pipette tip passes. As long as the pipette tip is disposed held in the opening 76, the edges of the temporary tear are displaced from each other by the pipette tip. After the pipette tip is withdrawn from the sample vial 10, the edges of the temporary tear are brought together by the elasticity of the membrane 78 and the intact portions thereof in a substantially contiguous closed configuration to substantially self-reseal the temporary tear in the membrane 78. The self-resealed membrane 78 is substantially fluid tight, especially combined with the small size of the temporary tear, the typically small volume of biological samples, and the surface tension of liquid samples.

The sample vial 10 may also include structure for sealing the body 12 and the cap 14 together, such as a separate seal 24, e.g., a gasket. As depicted in FIG. 5, the seal 24 is disposed and retained inside the cap 14. The seal 24 has an ellipsoid or circular shape with an opening underlying the opening 74 in the cap 14. In this embodiment, depending on the pitch of mating cap and body screw threads 32, 34, the compliance of the seal 24, the durometer of the seal 24, and the thickness of the seal 24, the required torque to form a fluid-tight seal between the cap 14 and the interior of the body 12 can range from about 5 inch-pounds or less to about 50 inch-pounds or more. In one embodiment, a fluid-tight seal is formed between the seal 24 and the interior of the body 12 when approximately 25 inch-pounds of torque is required to be applied to the cap 14 relative to the body 12 to unscrew the cap 14.

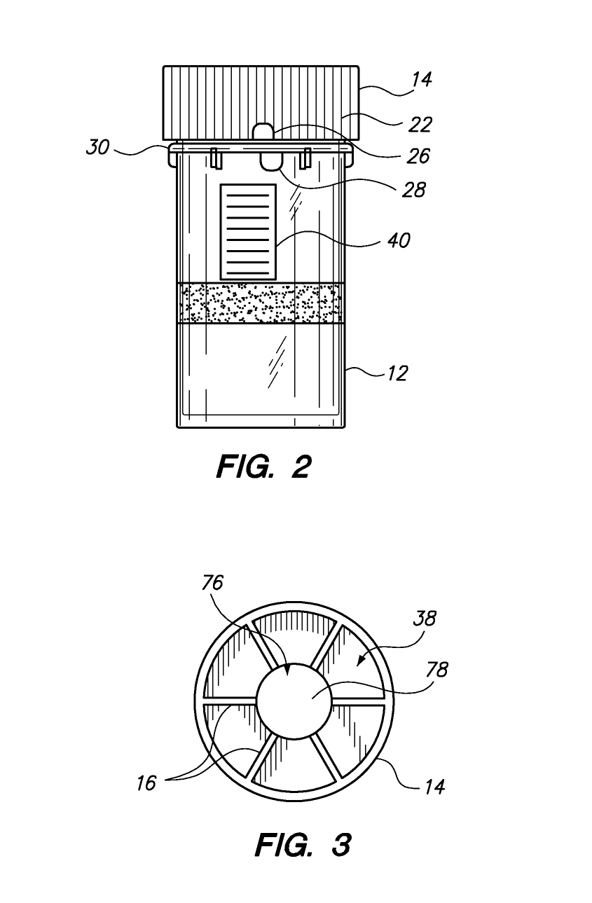

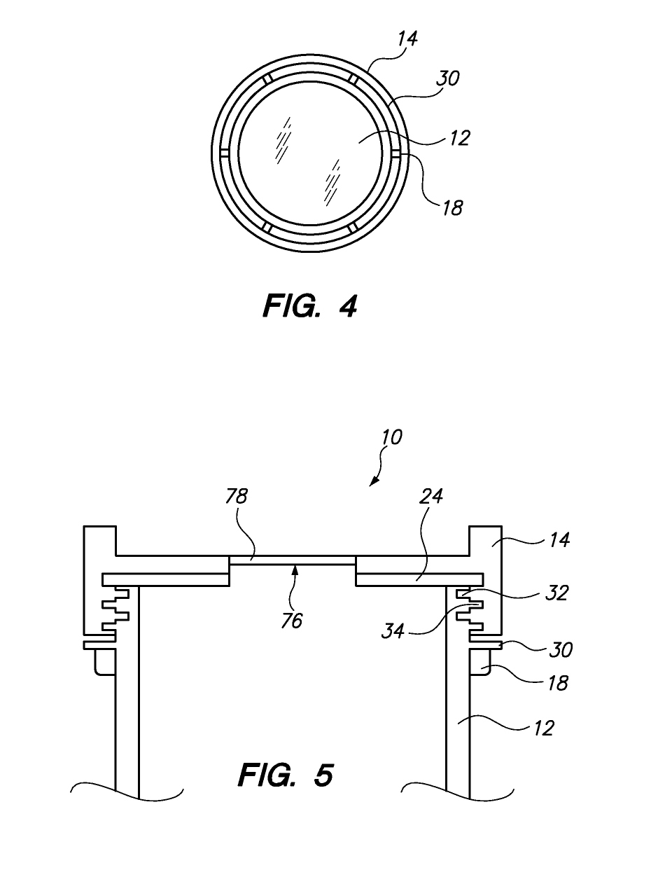

The cap 14 and the body 12 may advantageously include respective markers or marks 26, 28 that indicate a fluid-tight seal has been formed when the marks 26, 28 are at least aligned. As shown in FIGS. 1 and 2, the alignment marks 26, 28 indicate that more than sufficient torque has been applied, the cap alignment mark 26 having traveled slightly past the body alignment mark 28 for a standard right-hand threaded assembly.

If, however, excessive torque is applied and the cap 14 is overtightened on the body 12, the vial transfer assembly of the automated cytological specimen preparation system may be unable to remove the cap 14. Accordingly, proper positioning of the alignment marks 26, 28 on the body 12 and the cap 14 may be verified by measuring the torque required to remove the cap 14 from the body 12 during initial assembly of the vial 10. For example, proper positioning of the alignment marks 26, 28 may be verified when between about 15 to 25 inch-pounds of torque is required to remove the cap 14 from the body 12. The alignment marks 26, 28 may be used when manually reinstalling the cap 14 after depositing a patient cell sample in the preservative fluid to indicate, visually, that a substantially fluid-tight seal has been formed, without necessitating excessive tightening of the cap 14.

The body 12 may be manufactured from a translucent or transparent material to allow a user to see how much preservative fluid is in the vial 10. A suitable material is a polypropylene homopolymer, available from Amoco under the trade designation 4018. The sample vial cap 14 may be releasably engagable with the body 12 by mating screw threads 32, 34 and may be manufactured from a polypropylene random copolymer, available from Amoco under the trade designation 8949. These materials may be injection molded to rapidly and inexpensively produce the body 12 and the cap 14, although other suitable manufacturing processes may be utilized depending on the particular materials selected.

As discussed hereinabove, the seal 24 disposed between the interior of the body 12 and the cap 14 forms a fluid-tight seal when sufficient torque is applied to the cap 14 relative to the body 12. Sealing is important, to prevent both leakage and evaporation of the preservative solution in the vial 10. The seal 24 may be manufactured from a multicomposite material including a sufficiently thick, dense, resilient layer disposed on a vapor barrier. In one embodiment, the resilient layer is oriented toward the preservative to provide an effective seal. The seal 24 may include a synthetic olefin rubber or an elastomeric alloy co-extruded on a thin vapor barrier such as that available from Tri Seal International, Inc., located in Blauvelt, N.Y. and sold under the trade name Tri Seal SOR-171.

The seal 24 may be manufactured from any suitable material or materials which are capable of withstanding attack by the preservative solution in the vial 10. The solution may typically include an alcohol solution, such as methanol in a buffer. Due to the low viscosity and high vapor pressure of the preservative solution, as well as the very low density and high permeability of the vapor phase thereof, a high integrity, reliable seal composition is desired. Further, because preservative filled vials 10 may be stored for a year or more prior to use, and be subject to temperature extremes during transport and storage, the seal 24 should be capable of retaining its sealing characteristics and structural integrity for extended periods of time without excessive loss of fluid due to evaporation. The seal material also should not degrade and contaminate the preservative solution or sample.

As depicted in FIG. 1, the body 12 of the sample vial 10 includes fluid level indicia 20 by which a user may determine a proper amount of fluid to fill the vial 10 or that the vial is filled properly prior to addition of a patient's cells. The body 12 depicted is translucent, so that a user can see the fluid level inside the vial 10 from outside the vial 10. The fluid level indicia 20 may be a frosted annular band of a predetermined axial length disposed about a circumference of the body 12 at a predetermined axial location to indicate the acceptable fill range of the vial 10, so that a proper specimen can be prepared from the sample by the automated preparation system. Alternatively, the fluid level indicia may be a single fill line or an upper fill line and a lower fill line, in which the upper fill line indicates a maximum level to which the vial 10 should be filled, and the lower fill line indicates a minimum amount of fluid necessary to prepare a specimen from the sample.

In the embodiment depicted in FIG. 5, the cap 14 includes a first screw thread 32, and the body 12 includes a second, mating screw thread 34. The cap 14 and the body 12 are releasably engagable by means of the first and second screw threads 32, 34. In another embodiment, the cap 14 and body 12 are releasably engagable by a bayonet-style retention feature. Other structures enabling releasable engagement by the cap 14 and the body 12 will be apparent to those skilled in the art.

As shown in FIG. 2, the body 12 may also include sample indicia 40. The indicia 40 can be used to identify a patient to whom the sample corresponds, as well as a slide prepared from the sample contained in the sample vial 10. The sample indicia 40 may be machine-readable, such as a bar code, which can be read by the automated cytological specimen preparation system. The bar code can be on a label disposed on the body 12 or, alternatively, can be integral with the body 12.

As depicted, the body 12 of the vial 10 is generally cylindrical in shape, having an outer diameter of approximately 1 and 5/16 inches and an axial length of approximately 2 and ¾ inches. The cap 14 is generally cylindrical in shape, having an outer diameter of approximately 1 and 9/16 inches and an axial length of approximately 9/16 of an inch. The cap 14 has an upper surface that is generally ellipsoid or circular in shape. The torque pattern 38 includes six, radially disposed, substantially equally-spaced apart ribs 16, each approximately ⅛ of an inch in height. The body 12 includes six equi-spaced circumferentially disposed anti-rotation lugs 18 disposed approximately 7/16 of an inch from the open end of the body 12. The anti-rotation lugs 18 are approximately ⅛ of an inch in height and 1/16 of an inch in width. The fluid level indicia 20 is a frosted annular band with an axial length of approximately ¼ of an inch. The lower boundary of the band is disposed approximately ⅞ of an inch from the closed end of the body 12 and the upper boundary is disposed approximately 1 and ⅛ inch from the closed end of the body 12. The mating screw threads 32, 34 may have a pitch of about eight threads per inch.

FIG. 6 is a schematic perspective view of one design of a rotatable interface 42 having a torque pattern 44 for mating with the torque pattern 38 of the sample vial cap 14. The rotatable interface 42 is shown inverted, to better depict the interface torque pattern 44 formed therein. In this embodiment, the interface torque pattern 44 includes six raised wedge-shaped sectors 46. The sectors 46 are substantially equi-spaced about the interface 42, which is rotatable about a longitudinal axis 48 thereof, and sized to mate with the torque pattern 38 of the cap 14. Accordingly, the ribs 16 of the cap 14 fit in grooves 50 formed between the sectors 46 of the interface 42 and react against substantially vertical faces 36 of the sectors 46 to permit both loosening and tightening of the cap 14. Although the vertical faces 36 of the sectors 46 are longer than the ribs 16 of the cap 14, the ribs 16 fit in the grooves 50 and react against the vertical faces 36. The pie-shaped sectors 46 can also interact with caps having pie-shaped torque patterns, but lacking pierceable membranes. Accordingly, the interface torque pattern 44 is compatible with both the torque pattern 38 of the cap 14 and the torque pattern of a cap without a pierceable membrane, allowing the same rotatable interface 42 to be used with both types of caps.

To prevent rotation of the body 12 during these operations, the body 12 may be disposed in a sample vial tray forming a bore 52 having a unidirectional interface 54 along an edge 60 thereof for mating with the lugs 18 of the body 12, as depicted in FIG. 7. The interface 54 includes six ramps 56, each including a substantially vertical face 58 which abuts one of the body lugs 18. Accordingly, the capped vial 10 may be disposed in the bore 52 with the flange 30 supported along the edge 60. The rotatable interface 42 may then be engaged with and tighten the cap 14, to ensure a fluid-tight seal prior to removing the vial 10 from the sample tray. Due to the orientation of the ramps 56, the lugs 18 react against the ramp faces 58 during tightening to positively secure and prevent rotation of the body 12.

Once the cap 14 has been tightened, the vial transfer assembly may grasp the capped vial 10 about the circumference of the cap 14, remove the vial 10 from the bore 52 in the tray, and deposit the capped vial 10 in a bore 62 formed in a vial sleeve 64, such as that depicted in FIG. 8 in wire form representation. The six lugs 18 of the capped vial 10 are received in every other one of twelve axially extending slots 66 formed along an upper edge 68 of the sleeve 64, the flange 30 of the vial 10 being supported by the edge 68. Once in the bore 62 with the lugs 18 disposed in the slots 66, the sleeve 64 may be rotated in one or both directions to disperse the cells in the preservative solution prior to uncapping the vial 10. Thereafter, a pin or other structural feature of the system may engage a notch 70 formed in a flange 72 of the sleeve 64 to prevent rotation of the sleeve and the vial 10 disposed therein while the rotatable interface 42 engages and unscrews the cap 14. The cap 14 is retracted by the vial transfer assembly and the sample collector disposed in the preservative solution in the vial 10 to collect the cells against the filter thereof and thereafter transfer the cells to a slide. Once the cytological specimen has been prepared, the cap 14 is reoriented over the open vial 10 and screwed onto the body 12 until a substantially fluid-tight seal has been formed. The axially extending slots 66 which engage the lugs 18 form a bidirectional interface, to react against the body lugs 18 during both removal and installation of the cap 14 on the body 12. Each of the axial slots 66 may be formed to include, optionally, a generally circumferentially disposed portion, shown generally at 74, to lock a suitably sized lug (not shown) against axial translation, if desired.

Of course, other suitable materials, dimensions, and configurations for the body, the cap, the ribs, the lugs, the fluid level indicia, and other features of the sample vial will be apparent to those skilled in the art, those disclosed being provided as examples only. For example, while the mating ribs and sectors provide a positive, self-centering drive, other mating structure such as pins and annular tracks may be used. Further, the sample vial may be used in other applications and contain other than cytological samples in preservative solution.

The vial cap 14 and sample vial 10 described above can be used to allow access a sample in the sample vial 10 without removing the vial cap 14 or creating a permanent opening the cap. For example, a pipette with a blunt pipette tip can pierce the membrane 78 and withdraw a sample from a sample container 10. This piercing and withdrawing can be either manual or automatic, i.e. by a machine. After withdrawing the sample, the pipette tip is removed from the membrane 78 allowing it to self-reseal itself as described above. The withdrawn sample can be used for a test, such as a molecular test.

Consequently, the sample can be withdrawn from the sample vial 10 without contaminating an outer surface of the sample vial 10 with the sample. Further, the small temporary tear formed in the membrane 78 also minimizes splashing and spilling during processing of the sample in the sample container 10. Moreover, as long as the pipette and the pipette tip are free of contaminants, the sample can be withdrawn from the sample vial 10 without contaminating the sample remaining in the vial 10, which can then be used to prepare specimens for other tests.

This completes the description of the preferred and alternate embodiments of the invention. Those skilled in the art may recognize other equivalents to the specific embodiment described herein which equivalents are intended to be encompassed by the claims attached hereto.

What is claimed is:

1. A cap configured for use with a specimen container, the cap comprising:
a cap body having a top surface defining an opening therethrough;
a torque pattern disposed on the top surface of the cap body; and
a pierceable and self-resealing membrane disposed across the opening,
wherein, when the membrane is intact or resealed, the membrane forms a fluid-tight seal across the opening.

2. The cap of claim 1, wherein the top surface defines the opening approximately in a center of the torque pattern.

3. The cap of claim 1, wherein the membrane and the opening are configured such that, when the cap is attached to a specimen container, an interior of the specimen container is accessible through the membrane and cap opening.

4. The cap of claim 1, wherein the membrane is configured to self-seal a tear therein by returning opposite edges of the tear to a substantially contiguous closed condition.

5. The cap of claim 1, wherein the membrane comprises an elastomeric material.

6. The cap of claim 1, wherein the torque pattern comprises a plurality of radially disposed ribs.

7. The cap of claim 6, wherein the torque pattern comprises six, radially disposed, substantially equally-spaced apart ribs.

8. A sample vial for use in an automated test apparatus, comprising:
a vial body comprising an outer surface, with at least one anti-rotation lug disposed about the vial body outer surface;
a cap removably attachable to the vial body, said cap comprising
a cap body having a top surface defining an opening therethrough,
a torque pattern disposed on the top surface of the cap, and
a pierceable and self-resealing membrane disposed across the opening,
wherein, when the membrane is intact or resealed, the membrane forms a fluid-tight seal across the opening; and
a seal disposed between an interior of the vial body and the cap so as to be capable of forming a substantially fluid-tight seal therebetween when the membrane is intact or resealed.

9. The sample vial of claim 8, wherein the top surface defines the opening approximately in a center of the torque pattern.

10. The sample vial of claim 8, wherein the vial body, cap, and seal are configured such that the interior of the vial body is accessible without removing the cap from the vial body by piercing the membrane.

11. The sample vial of claim 8, wherein the membrane is configured to self-seal a tear therein by returning opposite edges of the tear to a substantially contiguous closed condition.

12. The sample vial of claim 8, wherein the membrane comprises an elastomeric material.

13. The sample vial of claim 8, wherein the torque pattern comprises a plurality of radially disposed ribs.

14. The sample vial of claim 8, wherein the vial body, cap, and seal are configured such that a substantially fluid-tight seal between the cap and the interior of the vial body is formed when between about 5 and 50 inch-pounds of torque is applied to the cap relative to the vial body.

15. The sample vial of claim 14, wherein the vial body, cap, and seal are configured such that a substantially fluid-tight seal between the cap and the interior of the vial body is formed when about 20 inch-pounds of torque is applied to the cap relative to the vial body.

16. The sample vial of claim 8,
wherein the cap comprises a first alignment marker,
wherein the vial body comprises a second alignment marker, and
wherein the first and second alignment markers indicate a fluid-tight seal when aligned.

17. The sample vial of claim 16, wherein the vial body, cap, and seal are configured such that, when the first marker is aligned with the second marker, the cap may be removed from the vial body by applying less than about 25 inch-pounds of torque to the cap relative to the vial body.

18. The sample vial of claim 8,
wherein the cap further comprises a first screw thread,
wherein the vial body further comprises a second mating screw thread, and
wherein the cap and the vial body are releasably engagable by an interaction between the first screw thread and the second mating screw thread.

19. A method of accessing a fluid in a biological specimen container without removing a cap attached thereto or creating a permanent opening in the cap, the method comprising:
applying torque to a torque pattern disposed on a top surface of the cap to confirm a fluid-tight seal exists between the cap and an interior region of the container;
piercing a membrane disposed on the cap with an elongate member;
accessing the fluid inside the biological specimen container through the membrane using the elongate member; and
removing the elongate member from the membrane to thereby allow the membrane to self-reseal.

20. The method of claim 19, further comprising accessing the fluid through the elongate member without contaminating an outer surface of the biological specimen container with the fluid.
